(19) United States
(12) Patent Application Publication
(10) Pub. No.: US 2007/0074633 A1
(43) Pub. Date: Apr. 5, 2007

(54) Multi-axes inker

(75) Inventor: Johnny Dai, Hsin-Chu City (TW)

Correspondence Address: BIRCH STEWART KOLASCH & BIRCH, PO BOX 747, FALLS CHURCH, VA, 22040-0747, US

(73) Assignee: KING YUAN ELECTRONICS CO., LTD., Hsin-Chu City (TW)

(21) Appl. No.: 11/296,303

(22) Filed: Dec. 8, 2005

(30) Foreign Application Priority Data
Sep. 30, 2005 (TW) 94134376

(51) Int. Cl. B41F 17/36; B41F 17/00

(52) U.S. Cl. 101/35

(57) ABSTRACT

An inker is usually used in electrical properties testing processes to mark the defective dies of the semiconductor wafer. However, the conventional inker having only one axis will be shaken during working time, resulting in making a mistake of marking the wrong dies. The present invention discloses a multi-axes inker to fix the problem. Another axis is added to the conventional inker. The new axis can help in restricting the original axis, so that the inker is stable and can mark the right dies without a mistake.

### FIELD OF THE INVENTION

The present invention relates to an inker device, more particularly relates to a multi-axes inker device.

### DESCRIPTION OF THE PRIOR ART

The fabrication of the semiconductor is included: IC design, wafer fabrication, wafer sort, IC packaging, and packaging test. In the wafer sort step, an inker is used to mark the defective die of the wafer after the defective die was distinguished from the operable dies. The present invention is about the improvement of the inker device and the probability of marking the wrong die can be reduced when the wafer die is too small.

FIG. 1 is a plan view of the multi-axes inker 10 in the prior art. The inker 10 comprises a driving device 110, an inker head 120, and an interconnecting shaft 130. The driving device 110 has an axis 1102. The inker head 120 is used to mark the defective die. Moreover, the driving device 110 further has a spiral 1104 and a magnetic circuit (not shown). The spiral 1104 is disposed in the top of the axis 1102. And the magnetic circuit is used to activate the spiral 1104 and then the spiral 1104 can let the axis 1102 move up and down.

In the wafer sort step, the dies are tested to distinguish which dies on the wafer don't work function properly. And those defective dies are marked by an inker and will not go to the IC packaging step. However, the conventional inker will mark at the wrong die because the inker is not stable and will move back and forth.

The modern technology is changed every day and the wafer die fabrication is become smaller and smaller, and the inker is easy to mark in the wrong die. It is necessary to provide an improvement structure of the inker device to efficiently and correctly mark the defective dies and reduce the probability of errors.

### SUMMARY OF THE INVENTION

The purpose of the present invention is to provide a multi-axes inker used to efficiently and correctly mark the ink in the defective die. Therefore, the probability of error can be reduced.

According to the description above, a multi-axes inker is disclosed in the present invention. In one embodiment of the present invention, the multi-axes inker has a driving device, an inker head, an anti-bias device, and an interconnecting shaft. The driving device has a first axis. The inker head is used to mark the defective die. The anti-bias device has a second axis. One end of the interconnecting shaft is connected to the first axis and the other end of the interconnecting shaft is connected to the second axis. Therefore, the anti-bias device can be used to reduce the rotation and the bias, which is caused by the first axis. Moreover, the driving device further has a spiral and a magnetic circuit. The spiral is disposed in the top of the first axis. And the magnetic circuit is used to activate the spiral and then the spiral can let the first axis move up and down. The multi-axes inker further has an ink storage, which is used to provide the ink for the ink head. The multi-axes inker of the present invention further comprises a transmissive device, which is connected to the driving device and let the driving device horizontally move back and forth. In addition, the anti-bias device of the multi-axes device is fixed in the driving device and the second axis of the inker is parallel to the first axis.

### BRIEF DESCRIPTION OF THE DRAWINGS

FIG. 1 is a plan view of the conventional inker device in the prior art.

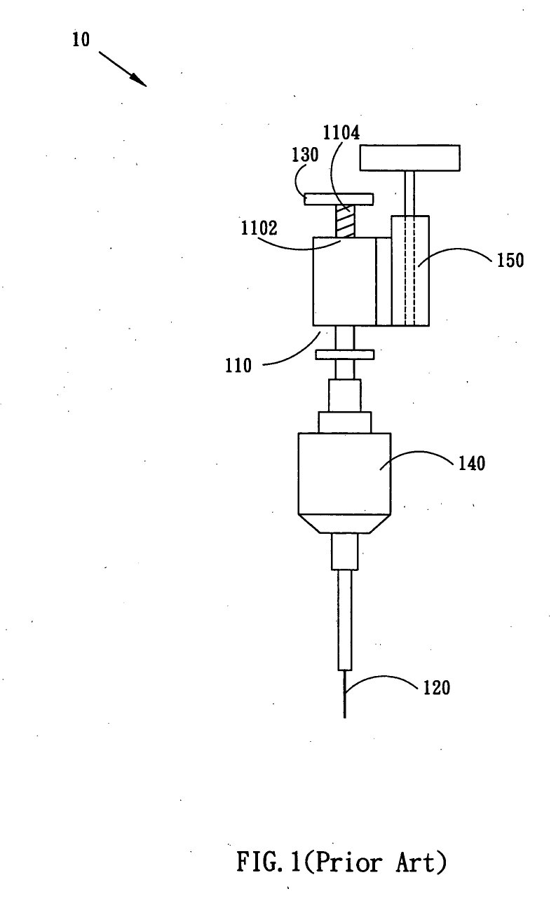

FIG. 2 is a plan view of the multi-axes inker device in the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

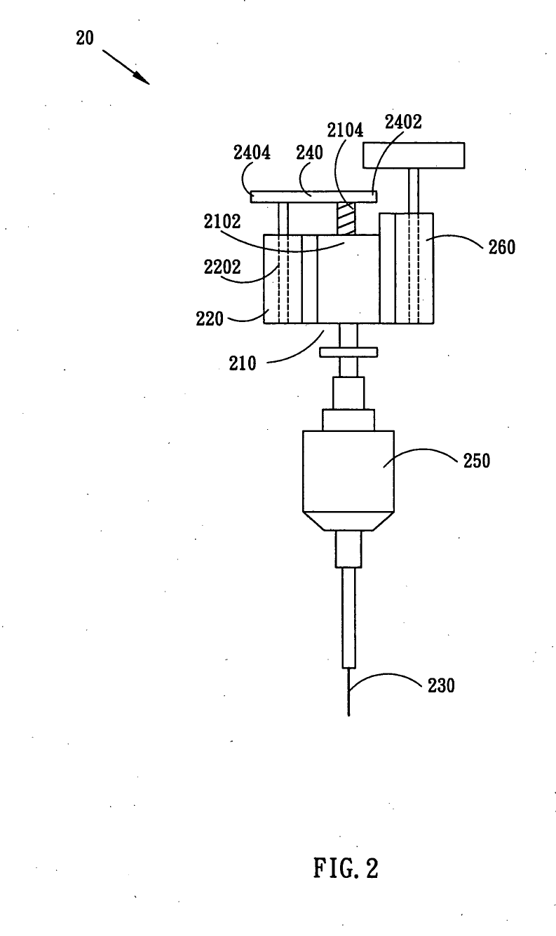

FIG. 2 is a plan view of the multi-axes inker 20 in the embodiment of the present invention. The multi-axes inker 20 comprises a driving device 210, an inker head 230, an anti-bias device 220 and an interconnecting shaft 240. The driving device 210 has a first axis 2102. The inker head 230 is used to mark the defective die. The anti-deflection device 220 has a second axis 2202. One end 2402 of the interconnecting shaft 240 is connected to the first axis 2102 and the other end 2404 of the interconnecting shaft 240 is connected to the second axis 2202. Therefore, the anti-bias device 220 can be used to reduce the rotation and the bias, which is caused by the first axis 2102. Moreover, the driving device 210 further has a spiral 2104 and a magnetic circuit (not shown). The spiral 2104 is disposed in the top of the first axis 2102. And the magnetic circuit is used to activate the spiral 2104 and then the spiral 2104 can let the first axis 2102 move up and down. The multi-axes inker 20 further has an ink storage 250, which is used to provide ink for the ink head 230. The multi-axes inker of the present invention further comprises a transmissive device 260, which is connected to the driving device 210 and let the driving device 210 horizontally move back and forth. In addition, the anti-bias device 220 of the multi-axes inker 20 is fixed in the driving device 210 and the second axis 2202 of the inker 20 is horizon to the first axis 2102.

The transmissive device of the multi-axes inker 20 carries the first axis 2102 of the driving device 210 to do the horizontal move. The second axis 2202 connected to the first axis 2102 by the interconnecting shaft 240 is moved in the same way. And the second axis 2202 is used to fix the first axis 2102 to be stable. Then the inker head 230 of the driving device 210 won't mark in the wrong die. The transmissive device 260 moves the driving device 210 to the defective die and the magnetic circuit starts to work and activate the spiral 2104. Then the spiral 2104 moves the first axis 2102 down to let the inker head 230 can mark ink in the defective die. Therefore, the process of marking the ink to the defective die is done.

In this preferred embodiment of the present invention, there is only one addition axis added in the multi-axes inker. In other embodiments of the present invention, there is more than one axis added in the multi-axes inker. It may also obtain the same result: the first axis would be stable and the probability of marking in wrong die can be reduced.

Although specific embodiments have been illustrated and described, it will be appreciated by those skilled in the art that various modifications may be made without departing from the scope of the present invention, which is intended to be limited solely by the appended claims.

What is claimed is:

1. A multi-axes inker, comprising:
a driving device comprising a first axis;
an inker head connected to said driving device, said inker head uses ink to mark a die;
at least one anti-bias device comprising a second axis; and
an interconnecting shaft comprising a first end and a second end, wherein said first end is connected to said first axis and said second end is connected to said second axis and said anti-bias device can be used to reduce the rotation and the bias, which is caused by said first axis.

2. The multi-axes inker of claim 1, wherein said driving device further comprising:
a spiral disposed in said first axis; and
a magnetic circuit used to activate said spiral and let said first axis move up and down.

3. The multi-axes inker of claim 1, further comprising an ink storage to store and provide the ink for inker head.

4. The multi-axes inker of claim 3, wherein said ink storage is connected between said driving device and said inker head.

5. The multi-axes inker of claim 1, further comprising a transmissive device connected to said driving device and carry said driving device to move horizontally.

6. The multi-axes inker of claim 1, wherein said anti-bias device is fixed in said transmissive device.

7. The multi-axes inker of claim 5, wherein said anti-bias device is fixed in said transmissive device.

8. The multi-axes inker of claim 1, wherein said second axis is parallel to said first axis.

9. A multi-axes inker, comprising:
a driving device comprising a first axis, wherein said driving device activates said first axis to move up and down;
an ink storage connected to said driving device and used to store and provide ink;
an inker head connected to said ink storage and mark ink in the surface of a die;
an anti-bias device comprising a second axis, wherein said second axis can move up and down within said anti-bias device; and
an interconnecting shaft comprising a first end and a second end, wherein said first end is connected to said first axis and said second end is connected to said second axis, and said anti-bias device can be used to reduce the rotation and the bias, which is caused by said first axis.

10. The multi-axes inker of claim 9, wherein said driving device further comprising:
a spiral disposed in said first axis; and
a magnetic circuit used to activate said spiral and let said first axis move up and down.

11. The multi-axes inker of claim 9, further comprising a transmissive device connected to said driving device and carry said driving device to move horizontally.

12. The multi-axes inker of claim 9, wherein said anti-bias device is fixed in said transmissive device.

13. The multi-axes inker of claim 11, wherein said anti-bias device is fixed in said transmissive device.
